(19) United States
(12) Patent Application Publication
(10) Pub. No.: US 2026/0163369 A1
(43) Pub. Date: Jun. 11, 2026

(54) FAULT DIAGNOSIS METHOD FOR HVDC TRANSMISSION SYSTEMS BASED ON SEQUENCE LINK PREDICTION OF SER EVENTS

(71) Applicant: Zhejiang University, Hangzhou (CN)

(72) Inventors: Yunfeng YAN, Hangzhou (CN); Bingyan GUO, Hangzhou (CN); Donglian QI, Hangzhou (CN); Weidan YAN, Hangzhou (CN); Xianbo WANG, Hangzhou (CN); Yulin CHEN, Hangzhou (CN)

(73) Assignee: Zhejiang University, Hangzhou (CN)

(21) Appl. No.: 19/344,640

(22) Filed: Sep. 30, 2025

(30) Foreign Application Priority Data
Dec. 7, 2024 (CN) 202411795804.5

(51) Int. Cl. H02J 3/00

(52) U.S. Cl. CPC H02J 3/0012

(57) ABSTRACT

A fault diagnosis method for HVDC transmission systems based on sequence link prediction of SER events is provided. Specifically, an event knowledge graph is introduced, direct-current project historical cases are integrated, an abnormal event knowledge graph for HVDC transmission systems taking an SER abnormal event as a core is constructed, and information gap between entities such as projects and faults and abnormal events are bridged, so that a navigable and reasonable global semantic network is formed, and deep coupling between business and knowledge is achieved. Moreover, a sequence link prediction task is defined, a fault diagnosis dataset for HVDC transmission systems is constructed, a pre-trained language model is introduced, a fault diagnosis model and system for HVDC transmission systems based on sequence link prediction of SER events is established, and hidden high-dimensional correlation features between projects, abnormal events and system faults are extracted, and fault diagnosis is completed autonomously.

### CROSS REFERENCE TO THE RELATED APPLICATIONS

This application is based upon and claims priority to Chinese Patent Application No. 202411795804.5, filed on Dec. 7, 2024, the entire contents of which are incorporated herein by reference.

### TECHNICAL FIELD

The present invention relates to the technical field of power system transmission safety, and specifically to a fault diagnosis method and system for HVDC transmission systems based on sequence link prediction of SER events.

### BACKGROUND

At present, with the rapid development and high-density access of renewable energy, a novel power system faces challenges such as uneven energy distribution and difficult fault analysis. As a core link of the novel power system, high voltage direct current (HVDC) transmission has the advantages of long transmission distance, large transmission capacity, and good economy.

The structure of HVDC transmission equipment is very complex and highly automated. When a fault or abnormal state occurs, the system will generate massive sequence of events recording (SER) data. SER data contains various status descriptions such as alarm groups, events, and levels, which is one of the important data for monitoring and evaluating the operating status of the power system, and has the characteristics of high real-time performance, large data volume, and strong serialization. The converter station generates about 100,000 pieces of SER data every day, which poses potential risks such as missing important signals, misjudging system status, and untimely operation and maintenance. Therefore, by mining the hidden fault features in massive SER data, intelligent fault diagnosis of HVDC transmission systems may be achieved to ensure safe and reliable operation of the system.

Currently, association rule mining is mainly used to analyze SER data, perform semi-automatic shallow layer feature extraction, and mine strong association rules between SER abnormal events and system faults, to assist operation and maintenance personnel in manually reviewing and judging fault types according to established rules, such as diagnosis of typical operation and maintenance events of converter stations based on association rules, extraction of similar fault features of SER data in the converter station, and SER data mining based on FP-Growth algorithm. The above research aims to mine the correlation between SER abnormal events and system failures, so as to assist in evaluating whether the system is abnormal. However, this research has the disadvantages of heavy reliance on manual work, poor real-time performance, and extremely low efficiency, which are mainly reflected in the following aspects:
1) Unable to extract hidden high-dimensional fault features: Existing research only performs feature extraction and association rule analysis on abnormal signal types, which cannot capture the rich semantic information and serialized structural features of SER abnormal events. The robustness and adaptability of the algorithm are weak;
2) Lack of scalable SER data analysis model: Due to differences in line structures and signal naming methods among different DC projects, it is impossible to fuse features of a plurality of projects and perform unified SER association rule joint modeling;
3) Unable to give diagnostic results autonomously: Existing research can only mine strong correlation rules between abnormal events and system failures, and cannot achieve intelligent diagnosis of system failures. Operation and maintenance personnel are still required to view SER data according to established rules, which has poor real-time performance and low efficiency.

Therefore, how to solve the above defects is an urgent problem to be solved by those skilled in the art.

### SUMMARY

In view of this, the present invention provides a fault diagnosis method and system for HVDC transmission systems based on sequence link prediction of SER events. An event knowledge graph (EKG) technology is introduced, a plurality of direct-current project historical cases are integrated, an abnormal event knowledge graph for HVDC transmission systems taking an SER abnormal event as a core is constructed, and information gap between entities such as projects and faults and abnormal events are bridged, so that a navigable and reasonable global semantic network is formed, and deep coupling between business and knowledge is achieved. Based on characteristics of SER data and experience of operation and maintenance experts, a sequence link prediction (SLP) task is defined, a fault diagnosis dataset for HVDC transmission systems is constructed, a pre-trained language model is introduced, the sequence link prediction models SLP-PLM(Mul) and SLP-PLM(Bin) of SER events for fault diagnosis of HVDC transmission systems are established, a fault diagnosis system for HVDC transmission systems based on sequence link prediction of SER events is established, hidden high-dimensional correlation features between projects, abnormal events and system faults are extracted, and fault diagnosis is completed autonomously, so that the problems of weak adaptability and low automation in the existing methods are solved.

To achieve the above objective, the present invention adopts the following technical solutions.

A fault diagnosis method for HVDC transmission systems based on sequence link prediction of SER events includes:
introducing an event knowledge graph technology into SER data analysis, and constructing an abnormal event knowledge graph for HVDC transmission systems;
defining a sequence link prediction task suitable for fault diagnosis of the HVDC transmission systems based on characteristics of SER data and expert experience in fault diagnosis;
based on the abnormal event knowledge graph for HVDC transmission systems and a corresponding historical fault example, generating an evolution link sequence of direct-current projects and SER abnormal events under system faults according to a sequence link prediction task form, and sampling various fault data by taking a fault case as a unit to obtain a fault diagnosis dataset for the HVDC transmission systems;
establishing a sequence link prediction model of SER events for fault diagnosis of the HVDC transmission systems;
training the sequence link prediction model of SER events by using the fault diagnosis dataset for the HVDC transmission systems to obtain a trained sequence link prediction model of SER events; and
inputting fault data of a to-be-tested HVDC transmission system into the sequence link prediction model of SER events to obtain a fault diagnosis result of the HVDC transmission systems.

Optionally, the process of constructing an abnormal event knowledge graph for HVDC transmission systems is as follows:
collecting historical cases from a plurality of direct-current projects covering extra-high voltage, flexible and conventional direct current, wherein the historical cases include SER files of each station and corresponding fault types;
designing an ontology architecture of the abnormal event knowledge graph for fault diagnosis of the HVDC transmission systems according to characteristics of SER data and the expert experience in fault diagnosis, wherein ontology triples include <project name, SOE alarm, abnormal event>, <abnormal event, next, abnormal event>, <abnormal event, diagnosis result, fault type>;
calculating text similarity between abnormal events of abnormal levels in SER data and standard protection signals by using a TextRank algorithm;
checking an abnormal event-protection signal text pair with the similarity larger than 0.5 to obtain abnormal event sequences of the cases and corresponding protection signal types; and
linking and aligning projects, abnormal event sequences and fault types according to the designed ontology architecture of the abnormal event knowledge graph to obtain the abnormal event knowledge graph for HVDC transmission systems.

Optionally, the text similarity is calculated by the following formula:

$$TextRank ( {t}_{AE} , {t}_{PS} ) = \frac{\vert w \vert w ∈ {t}_{AE} ⋂ w ∈ {t}_{PS} \vert}{log \vert {t}_{AE} \vert + log \vert {t}_{PS} \vert} ;$$

t_{AE} and t_{PS} are an abnormal event text and a protection signal text, respectively, and W is a word that simultaneously appears in the abnormal event text and the protection signal text.

Optionally, the process of defining a sequence link prediction task suitable for fault diagnosis of the HVDC transmission systems is as follows:
the knowledge graph is defined as G=(E,R,T,D), wherein E is an entity set, R is a relationship set, T is a triple set, and D is an entity text description set;
the sequence link prediction task is defined as: given an anchor entity sequence (a₁, a₂, . . . , aₖ)∈S and a relation r∈R, predicting an candidate entity c∈C, wherein S={(e₁, e₂, . . . , eₖ)|eᵢ∈E∧∃r∈R, (eᵢ,r,eᵢ₊₁)∈T} is an anchor entity sequence set, and CE is a candidate entity set; and the sequence link prediction task is simply formalized as (a₁, a₂, . . . , aₖ, r, ?), which is specifically divided into sequence scoring function modeling ψ:S×R×C→R and candidate entity probability distribution modeling f:S×R→C, wherein ? represents a task goal of predicting an candidate entity c, and R is a real number set.

Optionally, the process of establishing a sequence link prediction model of SER events for fault diagnosis of the HVDC transmission systems specifically includes:
introducing a pre-trained language model with a language understanding capability, extracting semantic features of sequence texts of SER events, constructing the sequence link prediction model of SER events for fault diagnosis of the HVDC transmission systems according to a sequence link prediction modeling paradigm of SER events, and achieving fault type candidate entity prediction.

Optionally, the sequence link prediction modeling paradigm of SER events is divided into sequence scoring function modeling and candidate entity probability distribution modeling;
for the input anchor entity sequence (a₁, a₂, . . . , aₖ)∈S and relation r∈R, sequence scoring function modeling calculates an SER event sequence score s=ψ(a₁, a₂, . . . , aₖ, r, c*) under any candidate entity c*∈C by using the pre-trained language model, and selects a candidate entity with the highest score as a prediction result:

$${c}_{pred} = {argmax}_{c * ∈ C} ψ ( {a}_{1} , {a}_{2} , … , {a}_{k} , r , c \text{*)} ;$$

a sequence scoring function modeling paradigm transforms sequence link prediction into a binary classification problem, enabling the model to fully model a high-dimensional semantic relationship between entities and relations and identify valid or invalid link sequences.

Candidate entity probability distribution modeling calculates probability distribution of candidate entities under given conditions through the pre-trained language model:

$${s}^{′} = P ( c * \vert {a}_{η} , {a}_{2} , … , {a}_{k} , r ) = f ( {a}_{η} , {a}_{2} , … , {a}_{k} , r ) ;$$

a candidate entity with the highest probability is taken as the prediction result:

$${c}_{pred} = {argmax}_{c * ∈ C} P ( c * \vert {a}_{1} , {a}_{2} , … , {a}_{k} , r ) ;$$

a candidate entity probability distribution modeling paradigm treats sequence link prediction as a multi-classification or sequence generation problem, and the model directly captures hidden association features among anchor entity sequences, relations and candidate entities.

Optionally, under a sequence scoring function modeling paradigm, the model is named as SLP-PLM(Bin), for a link sequence (a₁, a₂, . . . , aₖ, r, c), with a special token [CLS] as the first and a special token [SEP] as the last, all the node and relationship description texts in the sequence are segmented, and a context text is connected with the special token [SEP] to obtain a token sequence for fine-tuning the pre-trained language model; in the input sequence, each token is represented by a sum of a corresponding token embedding

$${E}_{token}^{i} ,$$

segmentation embedding

$${E}_{segment}^{i}$$

and position embedding

$${E}_{position}^{i} ,$$

and features of a token i are represented:

$${E}_{i} = {E}_{token}^{i} + {E}_{segment}^{i} + {E}_{position}^{i} ;$$

wherein for different node or relationship descriptions segmented by the special token [SEP], odd elements share the same segmentation embedding e_{odd}, while even elements share the same segmentation embedding eₑᵥₑₙ;
the pre-trained language model extracts link sequence structure features and semantic features from the input sequence, and uses a hidden vector C∈R^{H} corresponding to the special token [CLS] of a last layer of encoder or decoder as aggregate features for calculating sequence scores, wherein H is a hidden layer state dimension; a sequence scoring function is:

$$s = sigmoid ( {CW}^{T} ) ;$$

wherein s∈R² and W∈R^{2×H} are binary classification weight matrices; during fine-tuning, a pre-training parameter weight and a weight matrix W are optimized by using a gradient descent method, and a cross-entropy loss function is:

$$L = - {\sum }_{q ∈ {D}^{+} ⋃ {D}^{-}} ( ( 1 - {y}_{q} ) log ( {s}_{q 1} ) + {y}_{q} log ( {s}_{q 2} ) ) ;$$

wherein D⁺ is a positive example set of the link sequence, D⁻ is a negative example set of the link sequence, y_{q}∈{0,1} is a negative example/positive example label of the link sequence, and s_{q1}, s_{q2}∈[0,1] is a calculation score of the negative example and the positive example; since changing an anchor entity aᵢ in a positive example sequence leads to uncertainty in the candidate entity, a negative example sequence is obtained by randomly replacing a positive example candidate entity c:

$${D}^{-} = \{ ( {a}_{1} , {a}_{2} , … , {a}_{k} , r , {c}^{′} ) \vert {c}^{′} ∈ C ∧ c \neq {c}^{′} ∧ ( {a}_{1} , {a}_{2} , … , {a}_{k} , r , {c}^{′} ) ∉ {D}^{+} \} .$$

Optionally, under the candidate entity probability distribution modeling paradigm, the model is named as SLP-PLM(Mul), and compared with the SLP-PLM(Bin) model, only the candidate entity c in the link sequence is deleted, that is, (a₁, a₂, . . . , aₖ, r) is used as the input sequence for fine-tuning the pre-trained language model, and an hidden vector C corresponding to the special token [CLS] of the last layer of encoder or decoder is still used as aggregated feature representation of the input sequence to predict the candidate entity under the current event sequence; the probability distribution of the candidate entity is:

$${s}^{′} = softmax ( {CW}^{′ T} ) ;$$

wherein s′∈R^{|C|} and W′∈R^{|C|×H} are multi-classification weight matrices;
during fine-tuning, the cross-entropy loss function is:

$${L}^{′} = - {\sum }_{q ∈ {D}^{+}} {{\sum }^{\vert C \vert}}_{i = 1} {y}_{qi}^{′} log ( {s}_{qi}^{′} ) ;$$

wherein s′_{qi}∈[0,1], and

$${\sum }_{i}^{\vert C \vert} {s}_{qi}^{′} = 1 , {y}_{qi}^{′}$$

are an indicator function of the link sequence candidate entities,

$${y}_{qi}^{′} = 1$$

when the predicted candidate entity is true value, otherwise,

$${y}_{qi}^{′} = 0.$$

Optionally, the inputting fault data of a to-be-tested HVDC transmission system into the sequence link prediction model of SER events to obtain a fault diagnosis result of the HVDC transmission systems specifically includes:
before fault diagnosis of the HVDC transmission systems, firstly confirming an HVDC project name for executing fault diagnosis;
after confirming the HVDC project, extracting abnormal events that are in abnormal levels and contain standard protection signals from SER data;
after confirming the HVDC project and extracting an SER abnormal event, constructing a fault diagnosis link sequence, and executing text tokenization on the link sequence; and
after executing the text tokenization on the link sequence, sending a token sequence into a sequence link prediction model of SER events to obtain the fault diagnosis result of the HVDC transmission systems.

A fault diagnosis system for HVDC transmission systems based on sequence link prediction of SER events includes:
a knowledge graph construction module, configured to introduce an event knowledge graph technology into SER data analysis, and construct an abnormal event knowledge graph for HVDC transmission systems;
a task definition module, configured to define a sequence link prediction task suitable for fault diagnosis of the HVDC transmission systems based on characteristics of SER data and expert experience in fault diagnosis;
a dataset construction module, configured to, based on the abnormal event knowledge graph for HVDC transmission systems and a corresponding historical fault example, generate an evolution link sequence of direct-current projects and SER abnormal events under system faults according to a sequence link prediction task form, and sample various fault data by taking a fault case as a unit to obtain a fault diagnosis dataset for the HVDC transmission systems;
a model establishing module, configured to establish a sequence link prediction model of SER events for fault diagnosis of the HVDC transmission systems;
a model training module, configured to train the sequence link prediction model of SER events by using the fault diagnosis dataset for the HVDC transmission systems to obtain a trained sequence link prediction model of SER events; and
a fault diagnosis module, configured to input fault data of a to-be-tested HVDC transmission system into the sequence link prediction model of SER events to obtain a fault diagnosis result of the HVDC transmission systems.

It can be known from the technical solutions that, compared with the conventional technology, the present invention provides a fault diagnosis method and system for HVDC transmission systems based on sequence link prediction of SER events, which have the following beneficial effects.

1) In view of poor expandability of the conventional SER data analysis method, an event knowledge graph technology is introduced, a plurality of direct-current project historical cases are fused, an abnormal event knowledge graph for HVDC transmission systems taking an SER abnormal event as a core is constructed, and information gap between entities such as projects and faults and abnormal event are bridged, so that a navigable and reasonable global semantic network is formed, abundant semantic information and structural characteristics are provided, the characterization capability and expandability of SER data are remarkably improved, and deep coupling between business and knowledge is achieved.

2) In view of weak self-adaptive capacity, low automation and the like of the conventional SER data analysis method, a sequence link prediction (SLP) task is defined according to characteristics of SER data and expert experience in fault diagnosis, a fault diagnosis dataset for the HVDC transmission systems is constructed, a pre-trained language model is introduced, a sequence link prediction model of SER events facing the fault diagnosis of the HVDC transmission systems is established, and the model can self-adaptively capture fine-grained semantic information of the fault diagnosis dataset project, events and faults and hidden correlation features among the events and faults by jointly modeling the high-dimensional fault features of a plurality of direct-current projects, so that the fault diagnosis of the HVDC transmission systems is automatically and accurately achieved.

3) The fault diagnosis system for the HVDC transmission systems based on sequence link prediction of SER events is built, the analysis efficiency and the accuracy of SER abnormal event and the intelligent level of system operation and maintenance business are improved, the examination burden of operation and maintenance personnel is reduced, and the potential risk of threatening the safe and stable operation of a power grid is reduced.

### BRIEF DESCRIPTION OF THE DRAWINGS

To more clearly illustrate the technical solutions in the embodiments of the present invention or in the prior art, the drawings required to be used in the description of the embodiments or the prior art are briefly introduced below. It is obvious that the drawings in the description below are merely embodiments of the present invention, and those of ordinary skill in the art can obtain other drawings according to the drawings provided without creative efforts.

FIG. 1 is a schematic flow chart of a method according to the present invention;

FIG. 2 is an example diagram of an abnormal event knowledge graph for HVDC transmission systems according to the present invention;

FIG. 3 is an example diagram of a sequence link prediction task according to the present invention;

FIG. 4 is a schematic flow chart of a sequence link prediction modeling method of SER events according to the present invention;

FIG. 5 is a schematic diagram of an SLP-PLM (Bin) framework structure under sequence scoring function modeling according to the present invention; and

FIG. 6 is a schematic diagram of an SLP-PLM (Mul) framework structure under candidate entity probability distribution modeling according to the present invention.

### DETAILED DESCRIPTION OF THE EMBODIMENTS

The following clearly and completely describes the technical solutions in embodiments of the present invention with reference to the accompanying drawings in embodiments of the present invention. It is clear that the described embodiments are merely a part rather than all of embodiments of the present invention. Based on the embodiments of the present application, all other embodiments obtained by those of ordinary skill in the art without creative effort fall within the protection scope of the present application.

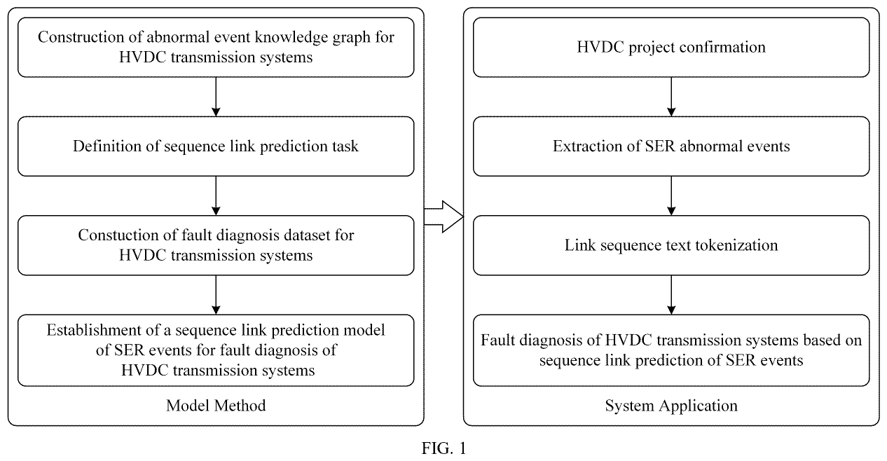

An embodiment of the present invention discloses a fault diagnosis method for HVDC transmission systems based on sequence link prediction of SER events, as shown in FIG. 1, which includes:
introducing an event knowledge graph technology into SER data analysis, and constructing an abnormal event knowledge graph for HVDC transmission systems;
defining a sequence link prediction task suitable for fault diagnosis of the HVDC transmission systems based on characteristics of SER data and expert experience in fault diagnosis;
based on the abnormal event knowledge graph for HVDC transmission systems and a corresponding historical fault example, generating an evolution link sequence of direct-current projects and SER abnormal events under system faults according to a sequence link prediction task form, and sampling various fault data by taking a fault case as a unit to obtain a fault diagnosis dataset for the HVDC transmission systems;
establishing a sequence link prediction model of SER events for fault diagnosis of the HVDC transmission systems;
training the sequence link prediction model of SER events by using the fault diagnosis dataset for the HVDC transmission systems to obtain a trained sequence link prediction model of SER events; and
inputting fault data of a to-be-tested HVDC transmission system into the sequence link prediction model of SER events to obtain a fault diagnosis result of the HVDC transmission systems.

In a specific embodiment, the process of constructing an abnormal event knowledge graph for HVDC transmission systems is as follows:
in the HVDC transmission systems, SER records system operation status information such as parameter over-limit, alarm events, and protection actions in real time, and serializes and outputs six types of data: time, host, system, level, alarm group, and event. The “host” is the device server that records events, “system” refers to a redundant system used, “level” represents the operation status level of the current event, which is generally divided into “normal”, “minor”, “alert” and “emergency”, “alarm group” is the device group or software that generates events, and “event” is the description of the current device operation status.

SER data has natural real-time and serial characteristics, and is often used to mine the evolution process of abnormal events under different direct-current projects and a mapping relationship between the abnormal events and system failures. Taking a 500 kV converter station in China as an example, tens of thousands pieces of SER data are generated on average every day, and the maximum can reach 500,000. The operation and maintenance personnel need to continuously pay attention to the real-time SER information, judge the current system operation status, and promptly discover the current fault type based on the sequence of abnormal protection action events generated by the alarm group, and take emergency measures to avoid the continued expansion of the scope of the accident.

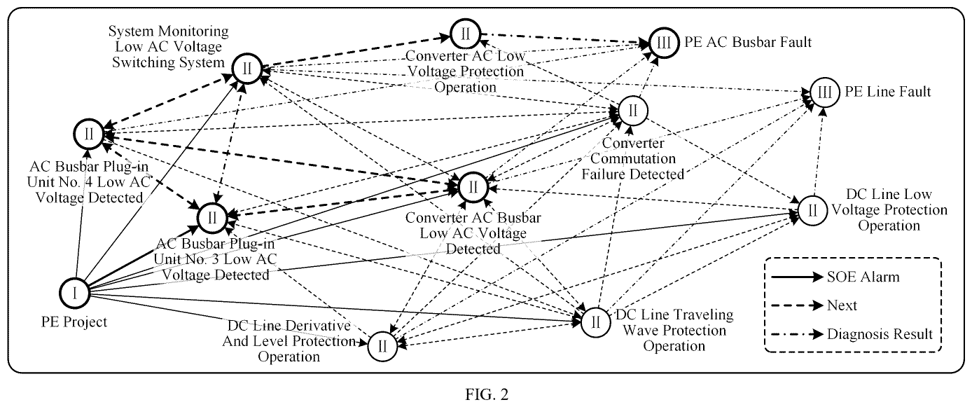

Based on characteristics of SER data and expert experience in fault diagnosis, event knowledge graph technology is introduced. “Project name”, “abnormal event” and “fault type” are used as node types, and “SOE alarm”, “next” and “diagnosis result” are used as relationships to connect “project name” and “abnormal event”, “abnormal event” and “abnormal event”, and “abnormal event” and “fault type” respectively, to construct the abnormal event knowledge graph for the HVDC transmission systems, as shown in FIG. 2 (case), where type I nodes represent the “project name” entity type, type II nodes represent the “abnormal event” event type, type III nodes represent the “fault type” entity type, and the “abnormal event” node is represented by the splicing of “alarm group” and “event” in the SER data. Compared with the traditional association rule representation method, the abnormal event knowledge graph bridges the information gap between projects, events and faults, forming a navigable and reasonable global network with rich semantic information and structural features, which significantly improves the representation ability and scalability of SER data. The detailed process is as follows:
collecting massive historical cases from a plurality of direct-current projects covering extra-high voltage, flexible and conventional direct current, wherein the historical cases include SER files of each station and corresponding fault types;
designing an ontology architecture of the abnormal event knowledge graph for fault diagnosis of the HVDC transmission systems according to characteristics of SER data and the expert experience in fault diagnosis, wherein ontology triples include <project name, SOE alarm, abnormal event>, <abnormal event, next, abnormal event>, <abnormal event, diagnosis result, fault type>;
calculating text similarity between abnormal events of abnormal levels in SER data and standard protection signals by using a TextRank algorithm:

$$TextRank ( {t}_{AE} , {t}_{PS} ) = \frac{\vert w \vert w ∈ {t}_{AE} ∩ w ∈ {t}_{PS} \vert}{log \vert {t}_{AE} \vert + log \vert {t}_{PS} \vert} ;$$

t_{AE} and t_{PS} are an abnormal event text and a protection signal text, respectively, and w is a word that simultaneously appears in the abnormal event text and the protection signal text.
checking an abnormal event-protection signal text pair with the similarity larger than 0.5 to obtain abnormal event sequences of the cases and corresponding protection signal types; and
linking and aligning projects, abnormal event sequences and fault types according to the designed ontology architecture of the abnormal event knowledge graph to obtain the abnormal event knowledge graph for HVDC transmission systems.

In a specific embodiment, the process of defining a sequence link prediction task suitable for fault diagnosis of the HVDC transmission systems is as follows:

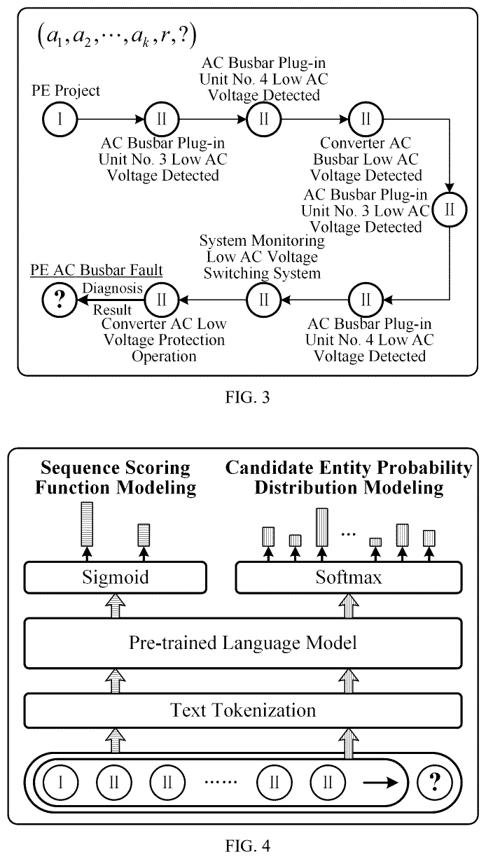

The fault diagnosis for HVDC transmission systems is to predict possible system faults under the condition of a given direct-current project and SER abnormal event evolution process. That is, given the link between the “project name” and the “abnormal event” node, the “fault type” node that the “diagnosis result” may point to is predicted. This is different from the traditional link prediction (LP) task and path query answering (PQA) task. Here, as shown in FIG. 3, a sequence link prediction (SLP) task suitable for fault diagnosis of HVDC transmission systems is redefined.

The knowledge graph is defined as G=(E,R,T,D), wherein E is an entity set, R is a relationship set, T is a triple set, and D is an entity text description set;
the sequence link prediction (SLP) task is defined as: given an anchor entity sequence (a₁, a₂, . . . , aₖ)∈S and a relation r∈R, predicting an candidate entity c∈C, wherein S={(e₁, e₂, . . . , eₖ)|eᵢE∧∃r∈R, (eᵢ,r,eᵢ₊₁)∈T} is an anchor entity sequence set, and C⊆E is a candidate entity set; and the sequence link prediction task is simply formalized as (a₁, a₂, . . . , aₖ, r, ?), which is specifically divided into sequence scoring function modeling ψ:S×R×C→R and candidate entity probability distribution modeling f:S×R→C, wherein ? represents a task goal of predicting an candidate entity c, and R is a real number set.

Compared with the traditional link prediction (LP) task, the input of the sequence link prediction task has more entities and more detailed prior information; and compared with the path query answering (PQA) task, the sequence link prediction task uses a more accurate entity sequence as the query path. Therefore, the sequence link prediction task combines the features of link prediction and path query answering, and is a new knowledge reasoning task.

In a specific embodiment, based on the abnormal event knowledge graph for the HVDC transmission systems and a corresponding historical fault example, an evolution link sequence of direct-current projects and SER abnormal events under system faults is generated according to the form of the sequence link prediction task, and the fault case link sequence dataset is obtained. Taking the case as the unit, various types of fault data are sampled in the ratio of 3:1:1 among training set, validation set and test set to obtain the fault diagnosis dataset for the HVDC transmission systems.

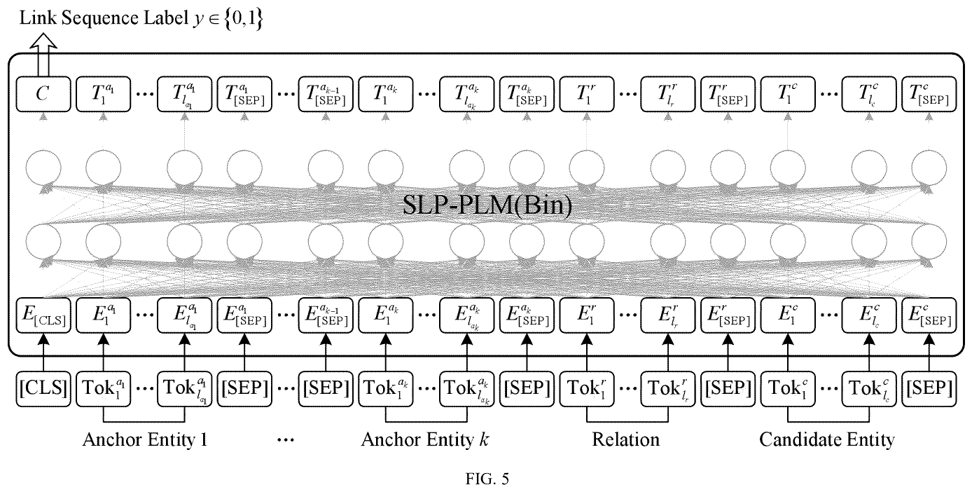

In a specific embodiment, to fully utilize semantic features of sequence texts of SER events, a pre-trained language model (PLM) is introduced, and candidate entity prediction is achieved by fine-tuning the pre-trained model. Here, the pre-trained language model includes, but is not limited to, autoencoder (encoder-only) models (such as BERT and ROBERTa), autoregressive (decoder-only) models (such as Qwen and Llama), encoder-decoder (encoder-decoder) models (such as GLM and BART). Based on the pre-trained language model with language understanding ability, a sequence link prediction model SLP-PLM of SER events for fault diagnosis of the HVDC transmission systems is established. The sequence link prediction modeling paradigm of SER events is divided into sequence scoring function modeling and candidate entity probability distribution modeling, as shown in FIG. 4.

For the input anchor entity sequence (a₁, a₂, . . . , aₖ)∈S and relation r∈R, sequence scoring function modeling calculates an SER event sequence score s=ψ(a₁, a₂, . . . , aₖ, r, c*) under any candidate entity c*∈C by using the pre-trained language model, and selects a candidate entity with the highest score as a prediction result:

$${c}_{pred} = {arg max}_{{c}^{*} ∈ C} ψ ( {a}_{1} , {a}_{2} , … , {a}_{k} , r , {c}^{*} ) ;$$

a sequence scoring function modeling paradigm transforms sequence link prediction into a binary classification problem, enabling the model to fully model a high-dimensional semantic relationship between entities and relations and identify valid or invalid link sequences.

Candidate entity probability distribution modeling calculates probability distribution of candidate entities under given conditions through the pre-trained language model:

$${s}^{′} = P ( {c}^{*} \vert {a}_{1} , {a}_{2} , … , {a}_{k} , r ) = f ( {a}_{1} , {a}_{2} , … , {a}_{k} , r ) ;$$

a candidate entity with the highest probability is taken as the prediction result:

$${c}_{pred} = {arg max}_{{c}^{*} ∈ C} P ( {c}^{*} \vert {a}_{1} , {a}_{2} , … , {a}_{k} , r ) ;$$

A candidate entity probability distribution modeling paradigm treats sequence link prediction as a multi-classification or sequence generation problem, and the model directly captures hidden association features among anchor entity sequences, relations and candidate entities, thereby avoiding scoring the traversal of all candidate entities.

Under the sequential scoring function modeling paradigm, the model is named SLP-PLM (Bin), and the model framework is shown in FIG. 5. For a link sequence (a₁, a₂, . . . , aₖ, r, c), with a special token [CLS] as the first and a special token [SEP] as the last, all the node and relationship description texts in the sequence are segmented, and a context text is connected with the special token [SEP] to obtain a token sequence for fine-tuning the pre-trained language model; in the input sequence, each token is represented by a sum of a corresponding token embedding

$${E}_{token}^{i} ,$$

segmentation embedding

$${E}_{segment}^{i}$$

and position embedding

$${E}_{position}^{i} ,$$

and features of a token i are represented:

$${E}_{i} = {E}_{token}^{i} + {E}_{segment}^{i} + {E}_{position}^{i} ;$$

wherein for different node or relationship descriptions segmented by the special token [SEP], odd elements share the same segmentation embedding e_{odd}, while even elements share the same segmentation embedding eₑᵥₑₙ;
the pre-trained language model extracts link sequence structure features and semantic features from the input sequence, and uses a hidden vector C∈R^{H} corresponding to the special token [CLS] of a last layer of encoder or decoder as aggregate features for calculating sequence scores, wherein H is a hidden layer state dimension;
a sequence scoring function is:

$$s = sigmoid ( {CW}^{T} ) ;$$

wherein s∈R² and W∈R^{2×H} are binary classification weight matrices; during fine-tuning, a pre-training parameter weight and a weight matrix W are optimized by using a gradient descent method;
a cross-entropy loss function is:

$$L = - {\sum }_{q ∈ {D}^{+} ⋃ {D}^{-}} ( ( 1 - {y}_{q} ) log ( {s}_{q 1} ) + {y}_{q} log ( {s}_{q 2} ) ) ;$$

wherein D⁺ is a positive example set of the link sequence, D⁻ is a negative example set of the link sequence, y_{q}∈{0,1} is a negative example/positive example label of the link sequence, and s_{q1},s_{q2}∈[0,1] is a calculation score of the negative example and the positive example;
since changing an anchor entity aᵢ in a positive example sequence leads to uncertainty in the candidate entity, a negative example sequence is obtained by randomly replacing a positive example candidate entity c:

$${D}^{-} = \{ ( {a}_{1} , {a}_{2} , ⋯ , {a}_{k} , r , {c}^{′} ) \vert {c}^{′} ∈ C \hat{} c \neq {c}^{′} \hat{} ( {a}_{1} , {a}_{2} , ⋯ , {a}_{k} , r , {c}^{′} ) ∉ {D}^{+} \} .$$

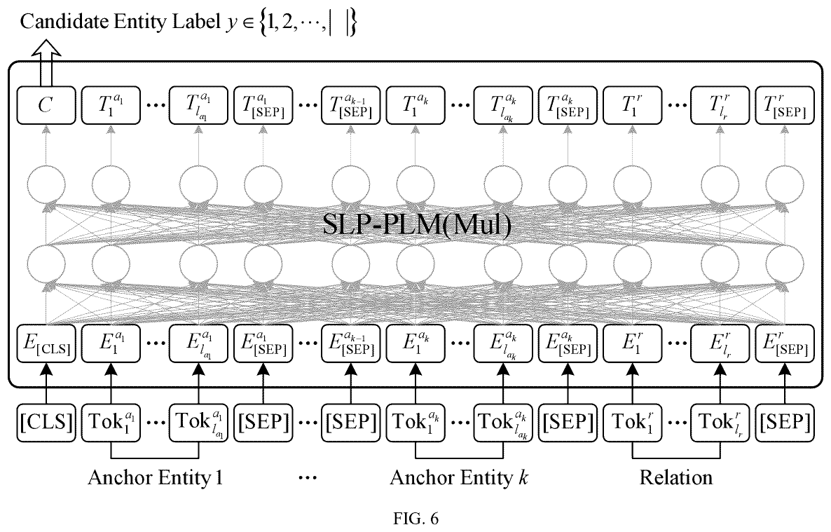

Under the candidate entity probability distribution modeling paradigm, the model is named SLP-PLM (Mul), and the model framework is shown in FIG. 6. Compared with the SLP-PLM(Bin) model, only the candidate entity c in the link sequence is deleted, that is, (a₁, a₂, . . . , aₖ, r) is used as the input sequence for fine-tuning the pre-trained language model, and an hidden vector C corresponding to the special token [CLS] of the last layer of encoder or decoder is still used as aggregated feature representation of the input sequence to predict the candidate entity under the current event sequence;
the probability distribution of the candidate entity is:

$${s}^{′} = soft max ( {CW}^{′ T} ) ;$$

wherein s′∈R^{|C|} and W′∈R^{|C|×H} are multi-classification weight matrices;
during fine-tuning, the cross-entropy loss function is:

$${L}^{′} = - {\sum }_{q ∈ {D}^{+}} {{\sum }_{i = 1}}^{\vert C \vert} {y}_{qi}^{′} log ( {s}_{qi}^{′} ) ;$$

wherein

$${\sum }_{i}^{\vert C \vert} {s}_{qi}^{′} = 1 ,$$

and

$${y}_{qi}^{′}$$

$${s}_{qi}^{′} ∈ [ 0 , 1 ] ,$$

are an indicator function of the link sequence candidate entities,

$${y}_{qi}^{′} = 1$$

when the predicted candidate entity is true value, otherwise,

$${y}_{qi}^{′} = 0.$$

In a specific embodiment, the inputting fault data of a to-be-tested HVDC transmission system into the sequence link prediction model of SER events to obtain a fault diagnosis result of the HVDC transmission systems specifically includes:

### HVDC Project Confirmation

Before fault diagnosis of the HVDC transmission systems, an HVDC project name for executing fault diagnosis is firstly confirmed. The system provides an HVDC project confirmation entrance for users to select or type in the HVDC project name. Here, the HVDC project specified by the user should belong to the scope of HVDC projects covered by the sequence link prediction model of SER events. If not, the user needs to be prompted.

### Extraction of SER Abnormal Events

After the HVDC project is confirmed, abnormal events that are in abnormal levels and contain standard protection signals are extracted from SER data. Here, the standard protection signal should belong to the specified HVDC project, and the abnormal event is represented by the combination of “alarm group” and “event” in the SER data. The system provides an SER data upload portal or network interface for users to select offline or online data. The Method for determining whether an abnormal event contains a standard protection signal includes, but is not limited to, token matching, fuzzy matching, semantic matching and other determination methods.

### Link Sequence Text Tokenization

After the HVDC project is confirmed and an SER abnormal event is extracted, a fault diagnosis link sequence is constructed, and text tokenization is performed on the link sequence. If the constructed sequence link prediction model of SER events belongs to the sequence scoring function modeling paradigm, the link sequence should contain the project name, abnormal event and fault type, as shown in FIG. 5. If the constructed sequence link prediction model of SER events belongs to the candidate entity probability distribution modeling paradigm, the link sequence should consist of the project name and the abnormal event link, as shown in FIG. 6. The text tokenization method should be applicable to the sequence link prediction model of SER events, including, but not limited to, subword-level tokenization, character-level tokenization, hybrid tokenization and other methods.

### Fault Diagnosis of the HVDC Transmission Systems Based on Sequence Link Prediction of SER Events

After the text tokenization is performed on the link sequence, a token sequence is sent into a sequence link prediction model of SER events to obtain the fault diagnosis result of the HVDC transmission systems. To facilitate user analysis and judgment, the system should display the N most confident fault types and confidence levels thereof in the diagnosis results, and provide a selection entry for the number of fault types to be displayed.

A fault diagnosis system for HVDC transmission systems based on sequence link prediction of SER events includes:
a knowledge graph construction module, configured to introduce an event knowledge graph technology into SER data analysis, and construct an abnormal event knowledge graph for HVDC transmission systems;
a task definition module, configured to define a sequence link prediction task suitable for fault diagnosis of the HVDC transmission systems based on characteristics of SER data and expert experience in fault diagnosis;
a dataset construction module, configured to, based on the abnormal event knowledge graph for HVDC transmission systems and a corresponding historical fault example, generate an evolution link sequence of direct-current projects and SER abnormal events under system faults according to a sequence link prediction task form, and sample various fault data by taking a fault case as a unit to obtain a fault diagnosis dataset for the HVDC transmission systems;
a model establishing module, configured to establish a sequence link prediction model of SER events for fault diagnosis of the HVDC transmission systems;
a model training module, configured to train the sequence link prediction model of SER events by using the fault diagnosis dataset for the HVDC transmission systems to obtain a trained sequence link prediction model of SER events; and
a fault diagnosis module, configured to input fault data of a to-be-tested HVDC transmission system into the sequence link prediction model of SER events to obtain a fault diagnosis result of the HVDC transmission systems.

Embodiments in this specification are all described in a progressive manner, for same or similar parts in embodiments, reference may be made to these embodiments, and each embodiment focuses on a difference from other embodiments. The apparatus disclosed in embodiments corresponds to the apparatus disclosed in embodiments, and therefore is briefly described. For related parts, refer to the descriptions of the apparatus.

The foregoing descriptions of the disclosed embodiments enable those skilled in the art to implement or use the present invention. The various modifications to the embodiments are clear to those skilled in the art, and the general principles defined herein may be implemented in another embodiment without departing from the spirit or scope of the present invention. Therefore, the present invention is not limited to the embodiments shown herein, but the present invention needs to conform to the widest range consistent with the principles and novel features disclosed herein.

1. A fault diagnosis method for high voltage direct current (HVDC) transmission systems based on sequence link prediction of sequence of events recording (SER) events, comprising:
introducing an event knowledge graph technology into SER data analysis, and constructing an abnormal event knowledge graph for the HVDC transmission systems;
defining a sequence link prediction task suitable for fault diagnosis of the HVDC transmission systems based on characteristics of SER data and expert experience in fault diagnosis;
based on the abnormal event knowledge graph for the HVDC transmission systems and a corresponding historical fault example, generating an evolution link sequence of direct-current projects and SER abnormal events under system faults according to a sequence link prediction task form, and sampling various fault data by taking a fault case as a unit to obtain a fault diagnosis dataset for the HVDC transmission systems;
establishing a sequence link prediction model of SER events for fault diagnosis of the HVDC transmission systems;
training the sequence link prediction model of SER events by using the fault diagnosis dataset for the HVDC transmission systems to obtain a trained sequence link prediction model of SER events;
inputting fault data of a to-be-tested HVDC transmission system into the trained sequence link prediction model of SER events to obtain a fault diagnosis result of the HVDC transmission systems; wherein
a process of establishing the sequence link prediction model of SER events for fault diagnosis of the HVDC transmission systems comprises:
introducing a pre-trained language model with a language understanding capability, extracting semantic features of sequence texts of SER events, constructing the sequence link prediction model of SER events for fault diagnosis of the HVDC transmission systems according to a sequence link prediction modeling paradigm of SER events, and achieving fault type candidate entity prediction; wherein
the sequence link prediction modeling paradigm of SER events is divided into sequence scoring function modeling and candidate entity probability distribution modeling.

2. The fault diagnosis method for the HVDC transmission systems based on sequence link prediction of SER events according to claim 1, wherein a process of constructing the abnormal event knowledge graph for the HVDC transmission systems is as follows:
collecting historical cases from a plurality of direct-current projects covering extra-high voltage, flexible and conventional direct current, wherein the historical cases comprise SER files of each station and corresponding fault types;
designing an ontology architecture of the abnormal event knowledge graph for fault diagnosis of the HVDC transmission systems according to the characteristics of the SER data and the expert experience in fault diagnosis, wherein ontology triples comprise <project name, SOE alarm, abnormal event>, <abnormal event, next, abnormal event>, <abnormal event, diagnosis result, fault type>;
calculating text similarity between abnormal events of abnormal levels in SER data and standard protection signals by using a TextRank algorithm;
checking an abnormal event-protection signal text pair with the text similarity larger than 0.5 to obtain abnormal event sequences of the cases and corresponding protection signal types; and
linking and aligning projects, abnormal event sequences and fault types according to the ontology architecture of the abnormal event knowledge graph to obtain the abnormal event knowledge graph for the HVDC transmission systems.

3. The fault diagnosis method for the HVDC transmission systems based on sequence link prediction of SER events according to claim 2, wherein the text similarity is calculated by the following formula:
$$TextRank ( {t}_{AE} , {t}_{PS} ) = \frac{\vert w \vert w ∈ {t}_{AE} ⋂ w ∈ {t}_{PS} \vert}{log \vert {t}_{AE} \vert + log \vert {t}_{PS} \vert} ;$$
wherein t_{AE} and t_{PS} are an abnormal event text and a protection signal text, respectively, and w is a word that simultaneously appears in the abnormal event text and the protection signal text.

4. The fault diagnosis method for the HVDC transmission systems based on sequence link prediction of SER events according to claim 1, wherein a process of defining the sequence link prediction task suitable for fault diagnosis of the HVDC transmission systems is as follows:
the abnormal event knowledge graph is defined as G=(E,R,T,D), wherein E is an entity set, R is a relationship set, T is a triple set, and D is an entity text description set; and
the sequence link prediction task is defined as: given an anchor entity sequence (a₁, a₂, . . . , aₖ)∈S and a relation r∈R, predicting a candidate entity c∈C, wherein S={(e₁, e₂, . . . , eₖ)|eᵢ∈E∧∃r∈R, (eᵢ,r,eᵢ₊₁)∈T} is an anchor entity sequence set, and C⊆E is a candidate entity set; and the sequence link prediction task is simply formalized as (a₁, a₂, . . . , aₖ, r, ?), and is divided into sequence scoring function modeling ψ:S×R×C→R and candidate entity probability distribution modeling f:S×R→C, wherein ? represents a task goal of predicting a candidate entity c, and R is a real number set.

5. The fault diagnosis method for the HVDC transmission systems based on sequence link prediction of SER events according to claim 1, wherein for the anchor entity sequence (a₁, a₂, . . . , aₖ)∈S and relation r∈R, sequence scoring function modeling calculates an SER event sequence score s=ψ(a₁, a₂, . . . , aₖ, r, c*) under any candidate entity c*∈C by using the pre-trained language model, and selects a candidate entity with a highest score as a prediction result:
$${c}_{pred} = {arg max}_{{c}^{*} ∈ C} ψ ( {a}_{1} , {a}_{2} , ⋯ , {a}_{k} , r , {c}^{*} ) ;$$
a sequence scoring function modeling paradigm transforms sequence link prediction into a binary classification problem, enabling the sequence link prediction model of SER events to fully model a high-dimensional semantic relationship between entities and relations and identify valid or invalid link sequences;
candidate entity probability distribution modeling calculates probability distribution of candidate entities under given conditions through the pre-trained language model:
$${s}^{′} = P ( {c}^{*} \vert {a}_{1} , {a}_{2} , … , {a}_{k} , r ) = f ( {a}_{1} , {a}_{2} , … , {a}_{k} , r ) ;$$
a candidate entity with a highest probability is taken as the prediction result:
$${c}_{pred} = {arg max}_{{c}^{*} ∈ C} P ( {c}^{*} \vert {a}_{1} , {a}_{2} , … , {a}_{k} , r ) ;$$
and
a candidate entity probability distribution modeling paradigm treats sequence link prediction as a multi-classification or sequence generation problem, and the sequence link prediction model of SER events directly captures hidden association features among anchor entity sequences, relations and candidate entities.

6. The fault diagnosis method for the HVDC transmission systems based on sequence link prediction of SER events according to claim 5, wherein under a sequence scoring function modeling paradigm, the sequence link prediction model of SER events is named as SLP-PLM(Bin), for a link sequence (a₁, a₂, . . . , aₖ, r, c), with a special token [CLS] as the first and a special token [SEP] as the last, all the node and relationship description texts in the link sequence are segmented, and a context text is connected with the special token [SEP] to obtain a token sequence for fine-tuning the pre-trained language model; in an input sequence, each token is represented by a sum of a corresponding token embedding
$${E}_{token}^{i} ,$$
segmentation embedding
$${E}_{segment}^{i}$$
and position embedding
$${E}_{position}^{i} ,$$
and features of a token i are represented as:
$${E}_{i} = {E}_{token}^{i} + {E}_{segment}^{i} + {E}_{position}^{i} ;$$
wherein for different node or relationship descriptions segmented by the special token [SEP], odd elements share a same first segmentation embedding e_{odd}, while even elements share a same second segmentation embedding eₑᵥₑₙ;
the pre-trained language model extracts link sequence structure features and semantic features from the input sequence, and uses a hidden vector C∈R^{H} corresponding to the special token [CLS] of a last layer of encoder or decoder as aggregate features for calculating sequence scores, wherein H is a hidden layer state dimension; a sequence scoring function is expressed as:
$$s = sigmoid ( {CW}^{T} ) ;$$
wherein S∈R² and W∈R^{2×H} are binary classification weight matrices; during fine-tuning, a pre-training parameter weight and a weight matrix W are optimized by using a gradient descent method, and a cross-entropy loss function is expressed as:
$$L = - {\sum }_{q ∈ {D}^{+} ⋃ {D}^{-}} ( ( 1 - {y}_{q} ) log ( {s}_{q 1} ) + {y}_{q} log ( {s}_{q 2} ) ) ;$$
wherein D⁺ is a positive example set of the link sequence, D⁻ is a negative example set of the link sequence, y_{q}∈{0,1} is a negative example/positive example label of the link sequence, and s_{q1}, s_{q2}∈[0,1] is a calculation score of a negative example and a positive example; since changing an anchor entity aᵢ in a positive example sequence leads to uncertainty in the candidate entity, a negative example sequence is obtained by randomly replacing a positive example candidate entity c:
$${D}^{-} = \{ ( {a}_{1} , {a}_{2} , … , {a}_{k} , r , {c}^{′} ) \vert {c}^{′} ∈ C ∧ c \neq {c}^{′} ∧ ( {a}_{1} , {a}_{2} , … , {a}_{k} , r , {c}^{′} ) ∉ {D}^{+} \} .$$

7. The fault diagnosis method for the HVDC transmission systems based on sequence link prediction of SER events according to claim 6, wherein under the candidate entity probability distribution modeling paradigm, the sequence link prediction model of SER events is named as SLP-PLM(Mul), and compared with the SLP-PLM(Bin) model, only the candidate entity c in the link sequence is deleted, that is, (a₁, a₂, . . . , aₖ, r) is used as the input sequence for fine-tuning the pre-trained language model, and an hidden vector C corresponding to the special token [CLS] of the last layer of encoder or decoder is still used as aggregated feature representation of the input sequence to predict the candidate entity under a current event sequence; a probability distribution of the candidate entity is expressed as:
$${s}^{′} = softmax ( {CW}^{′ T} ) ;$$
wherein s′∈R^{|C|} and W′∈R^{|C|×H} are multi-classification weight matrices;
during fine-tuning, the cross-entropy loss function is expressed as:
$${L}^{′} = - {\sum }_{q ∈ {D}^{+}} {{\sum }^{\vert C \vert}}_{i = 1} {y}_{qi}^{′} log ( {s}_{qi}^{′} ) ;$$
wherein s′_{qi}∈[0,1], and
$${\sum }_{i}^{\vert C \vert} {s}_{qi}^{′} = 1 ,$$
$${y}_{qi}^{′}$$
are an indicator function of the link sequence candidate entities,
$${y}_{qi}^{′} = 1$$
when a predicted candidate entity is true value, otherwise,
$${y}_{qi}^{′} = 0.$$

8. The fault diagnosis method for the HVDC transmission systems based on sequence link prediction of SER events according to claim 1, wherein the step of inputting the fault data of the to-be-tested HVDC transmission system into the sequence link prediction model of SER events to obtain the fault diagnosis result of the HVDC transmission systems comprises:
before fault diagnosis of the HVDC transmission systems, firstly confirming an HVDC project name for executing fault diagnosis;
after confirming the HVDC project, extracting abnormal events that are in abnormal levels and contain standard protection signals from the SER data;
after confirming the HVDC project and extracting an SER abnormal event, constructing a fault diagnosis link sequence, and executing text tokenization on the fault diagnosis link sequence; and
after executing the text tokenization on the fault diagnosis link sequence, sending a token sequence into the sequence link prediction model of SER events to obtain the fault diagnosis result of the HVDC transmission systems.

9. A fault diagnosis system for HVDC transmission systems based on sequence link prediction of SER events, applied to the fault diagnosis method for the HVDC transmission systems based on sequence link prediction of SER events according to claim 1, and comprising:
a knowledge graph construction module, configured to introduce the event knowledge graph technology into SER data analysis, and construct the abnormal event knowledge graph for the HVDC transmission systems;
a task definition module, configured to define the sequence link prediction task suitable for fault diagnosis of the HVDC transmission systems based on the characteristics of the SER data and the expert experience in fault diagnosis;
a dataset construction module, configured to, based on the abnormal event knowledge graph for the HVDC transmission systems and the corresponding historical fault example, generate the evolution link sequence of the direct-current projects and the SER abnormal events under the system faults according to the sequence link prediction task form, and sample various fault data by taking the fault case as the unit to obtain the fault diagnosis dataset for the HVDC transmission systems;
a model establishing module, configured to establish the sequence link prediction model of SER events for fault diagnosis of the HVDC transmission systems;
a model training module, configured to train the sequence link prediction model of SER events by using the fault diagnosis dataset for the HVDC transmission systems to obtain the trained sequence link prediction model of SER events; and
a fault diagnosis module, configured to input the fault data of the to-be-tested HVDC transmission system into the trained sequence link prediction model of SER events to obtain the fault diagnosis result of the HVDC transmission systems.

10. The fault diagnosis system for the HVDC transmission systems based on sequence link prediction of SER events according to claim 9, wherein in the fault diagnosis method for the HVDC transmission systems based on sequence link prediction of SER events, a process of constructing the abnormal event knowledge graph for the HVDC transmission systems is as follows:
collecting historical cases from a plurality of direct-current projects covering extra-high voltage, flexible and conventional direct current, wherein the historical cases comprise SER files of each station and corresponding fault types;
designing an ontology architecture of the abnormal event knowledge graph for fault diagnosis of the HVDC transmission systems according to the characteristics of the SER data and the expert experience in fault diagnosis, wherein ontology triples comprise <project name, SOE alarm, abnormal event>, <abnormal event, next, abnormal event>, <abnormal event, diagnosis result, fault type>;
calculating text similarity between abnormal events of abnormal levels in SER data and standard protection signals by using a TextRank algorithm;
checking an abnormal event-protection signal text pair with the text similarity larger than 0.5 to obtain abnormal event sequences of the cases and corresponding protection signal types; and
linking and aligning projects, abnormal event sequences and fault types according to the ontology architecture of the abnormal event knowledge graph to obtain the abnormal event knowledge graph for the HVDC transmission systems.

11. The fault diagnosis system for the HVDC transmission systems based on sequence link prediction of SER events according to claim 10, wherein in the fault diagnosis method for the HVDC transmission systems based on sequence link prediction of SER events, the text similarity is calculated by the following formula:
$$TextRank ( {t}_{AE} , {t}_{PS} ) = \frac{\vert w \vert w ∈ {t}_{AE} ⋂ w ∈ {t}_{PS} \vert}{log \vert {t}_{AE} \vert + log \vert {t}_{PS} \vert} ;$$
wherein t_{AE} and t_{PS} are an abnormal event text and a protection signal text, respectively, and w is a word that simultaneously appears in the abnormal event text and the protection signal text.

12. The fault diagnosis system for the HVDC transmission systems based on sequence link prediction of SER events according to claim 9, wherein in the fault diagnosis method for the HVDC transmission systems based on sequence link prediction of SER events, a process of defining the sequence link prediction task suitable for fault diagnosis of the HVDC transmission systems is as follows:
the abnormal event knowledge graph is defined as G=(E,R,T,D), wherein E is an entity set, R is a relationship set, T is a triple set, and D is an entity text description set; and
the sequence link prediction task is defined as: given an anchor entity sequence (a₁, a₂, . . . , aₖ)∈S and a relation r∈R, predicting a candidate entity c∈C, wherein S={(e₁, e₂, . . . , eₖ)|eᵢ∈E∧∃r∈R, (eᵢ, r, eᵢ₊₁)∈T} is an anchor entity sequence set, and C⊆E is a candidate entity set; and the sequence link prediction task is simply formalized as (a₁, a₂, . . . , aₖ, r, ?), and is divided into sequence scoring function modeling ψ:S×R×C→R and candidate entity probability distribution modeling f:S×R→C, wherein ? represents a task goal of predicting a candidate entity c, and R is a real number set.

13. The fault diagnosis system for the HVDC transmission systems based on sequence link prediction of SER events according to claim 9, wherein in the fault diagnosis method for the HVDC transmission systems based on sequence link prediction of SER events, for the anchor entity sequence (a₁, a₂, . . . , aₖ)∈S and relation r∈R, sequence scoring function modeling calculates an SER event sequence score s=ψ(a₁, a₂, . . . , aₖ, r, c*) under any candidate entity c*∈C by using the pre-trained language model, and selects a candidate entity with a highest score as a prediction result:
$${c}_{pred} = {arg max}_{{c}^{*} ∈ C} ψ ( {a}_{1} , {a}_{2} , ⋯ , {a}_{k} , r , {c}^{*} ) ;$$
a sequence scoring function modeling paradigm transforms sequence link prediction into a binary classification problem, enabling the sequence link prediction model of SER events to fully model a high-dimensional semantic relationship between entities and relations and identify valid or invalid link sequences;
candidate entity probability distribution modeling calculates probability distribution of candidate entities under given conditions through the pre-trained language model:
$${s}^{′} = P ( {c}^{*} \vert {a}_{1} , {a}_{2} , ⋯ , {a}_{k} , r ) = f ( {a}_{1} , {a}_{2} , ⋯ , {a}_{k} , r ) ;$$
a candidate entity with a highest probability is taken as the prediction result:
$${c}_{pred} = {arg max}_{{c}^{*} ∈ C} ψ ( {c}^{*} \vert {a}_{1} , {a}_{2} , ⋯ , {a}_{k} , r ) ;$$
and
a candidate entity probability distribution modeling paradigm treats sequence link prediction as a multi-classification or sequence generation problem, and the sequence link prediction model of SER events directly captures hidden association features among anchor entity sequences, relations and candidate entities.

14. The fault diagnosis system for the HVDC transmission systems based on sequence link prediction of SER events according to claim 13, wherein in the fault diagnosis method for the HVDC transmission systems based on sequence link prediction of SER events, under a sequence scoring function modeling paradigm, the sequence link prediction model of SER events is named as SLP-PLM(Bin), for a link sequence (a₁, a₂, . . . , aₖ, r, c), with a special token [CLS] as the first and a special token [SEP] as the last, all the node and relationship description texts in the link sequence are segmented, and a context text is connected with the special token [SEP] to obtain a token sequence for fine-tuning the pre-trained language model; in an input sequence, each token is represented by a sum of a corresponding token embedding Eₜₒₖₑₙⁱ, segmentation embedding E_{segment}ⁱ and position embedding Eₚₒₛᵢₜᵢₒₙⁱ, and features of a token i are represented as:
$${E}_{i} = {E}_{token}^{i} + {E}_{segment}^{i} + {E}_{position}^{i} ;$$
wherein for different node or relationship descriptions segmented by the special token [SEP], odd elements share a same first segmentation embedding e_{odd}, while even elements share a same second segmentation embedding eₑᵥₑₙ;
the pre-trained language model extracts link sequence structure features and semantic features from the input sequence, and uses a hidden vector C∈R^{H} corresponding to the special token [CLS] of a last layer of encoder or decoder as aggregate features for calculating sequence scores, wherein H is a hidden layer state dimension; a sequence scoring function is expressed as:
$$s = sigmoid ( {CW}^{T} )$$
wherein S∈R² and W∈R^{2×H} are binary classification weight matrices; during fine-tuning, a pre-training parameter weight and a weight matrix W are optimized by using a gradient descent method, and a cross-entropy loss function is expressed as:
$$L = - {\sum }_{q ∈ {D}^{+} ⋃ {D}^{-}} ( ( 1 - {y}_{q} ) log ( {s}_{q 1} ) + {y}_{q} log ( {s}_{q 2} ) ) ;$$
wherein D⁺ is a positive example set of the link sequence, D⁻ is a negative example set of the link sequence, y_{q}∈{0,1} is a negative example/positive example label of the link sequence, and s_{q1},s_{q2}∈[0,1] is a calculation score of a negative example and a positive example; since changing an anchor entity aᵢ in a positive example sequence leads to uncertainty in the candidate entity, a negative example sequence is obtained by randomly replacing a positive example candidate entity c:
$${D}^{-} = \{ ( {a}_{1} , {a}_{2} , ⋯ , {a}_{k} , r , {c}^{′} ) \vert {c}^{′} ∈ C ⋀ c \neq {c}^{′} ⋀ ( {a}_{1} , {a}_{2} , ⋯ , {a}_{k} , r , {c}^{′} ) ∉ {D}^{+} \} .$$

15. The fault diagnosis system for the HVDC transmission systems based on sequence link prediction of SER events according to claim 14, wherein in the fault diagnosis method for the HVDC transmission systems based on sequence link prediction of SER events, under the candidate entity probability distribution modeling paradigm, the sequence link prediction model of SER events is named as SLP-PLM(Mul), and compared with the SLP-PLM(Bin) model, only the candidate entity c in the link sequence is deleted, that is, (a₁, a₂, . . . , aₖ, r) is used as the input sequence for fine-tuning the pre-trained language model, and an hidden vector C corresponding to the special token [CLS] of the last layer of encoder or decoder is still used as aggregated feature representation of the input sequence to predict the candidate entity under a current event sequence; a probability distribution of the candidate entity is expressed as:
$${s}^{′} = softmax ( {CW}^{′ T} ) ;$$
wherein s′∈R^{|C|} and W′∈R^{|C|×H} are multi-classification weight matrices;
during fine-tuning, the cross-entropy loss function is expressed as:
$${L}^{′} = - {\sum }_{q ∈ {D}^{+}} {\sum }_{i = 1}^{\vert C \vert} {y}_{qi}^{′} log ( {s}_{qi}^{′} ) ;$$
wherein
$${s}_{qi}^{′} ∈ [ 0 , 1 ]$$
and
$${\sum }_{i}^{\vert C \vert} {s}_{qi}^{′} = 1 ,$$
$${y}_{qi}^{′}$$
are an indicator function of the link sequence candidate entities,
$${y}_{qi}^{′} = 1$$
when a predicted candidate entity is true value, otherwise,
$${y}_{qi}^{′} = 0.$$

16. The fault diagnosis system for the HVDC transmission systems based on sequence link prediction of SER events according to claim 9, wherein in the fault diagnosis method for the HVDC transmission systems based on sequence link prediction of SER events, the step of inputting the fault data of the to-be-tested HVDC transmission system into the sequence link prediction model of SER events to obtain the fault diagnosis result of the HVDC transmission systems comprises:
before fault diagnosis of the HVDC transmission systems, firstly confirming an HVDC project name for executing fault diagnosis;
after confirming the HVDC project, extracting abnormal events that are in abnormal levels and contain standard protection signals from the SER data;
after confirming the HVDC project and extracting an SER abnormal event, constructing a fault diagnosis link sequence, and executing text tokenization on the fault diagnosis link sequence; and
after executing the text tokenization on the fault diagnosis link sequence, sending a token sequence into the sequence link prediction model of SER events to obtain the fault diagnosis result of the HVDC transmission systems.
